(19) United States
(12) Patent Application Publication
(10) Pub. No.: US 2005/0085303 A1
(43) Pub. Date: Apr. 21, 2005

(54) Compensating coupling

(75) Inventors: Matthias Geislinger, Salzburg (AT); Cornelius Geislinger, Salzburg (AT)

Correspondence Address: Kurt Kelman;COLLARD & ROE, P.C., 1077 Northern Boulevard, Roslyn, NY, 11576, US

(73) Assignee: ELLERGON Antriebstechnik GmbH, Hallwang (AT)

(21) Appl. No.: 10/964,900

(22) Filed: Oct. 14, 2004

(30) Foreign Application Priority Data
Oct. 20, 2003 (AT) A 1655/2003

(51) Int. Cl. F16D 3/52

(52) U.S. Cl. 464/91

(57) ABSTRACT

The invention relates to a compensating coupling for a drive connection of two shafts (1, 2) with a coupling sleeve (4) which is made of fiber-reinforced plastic and connects two face-side membranes (3) and consists of two sleeve sections (8) which are screwed together with each other via radially outwardly projecting connecting flanges (9), with the ring-disk-like membranes (3) forming in the region of their inner circumference a connecting flange (5) with pass-through holes (12) for fastening screws (14), which holes are arranged along a graduated circle, and with the membranes being integrally joined to the coupling sleeve (8) at their outside circumference. In order to provide advantageous constructional conditions it is proposed that the coupling sleeve (8) has a smaller outside diameter (d) than the graduated circle diameter (D) reduced by the diameter of the pass-through holes (12) of the connecting flange (5), that the sleeve sections (8) comprise face-side wall disks (10) which are adjacent to the associated membranes (3) through a circumferential wall (11), and that coaxial engagement openings (13) for fastening screws (14) are provided in the wall disks (10) for the pass-through openings (12) of the connecting flanges (5).

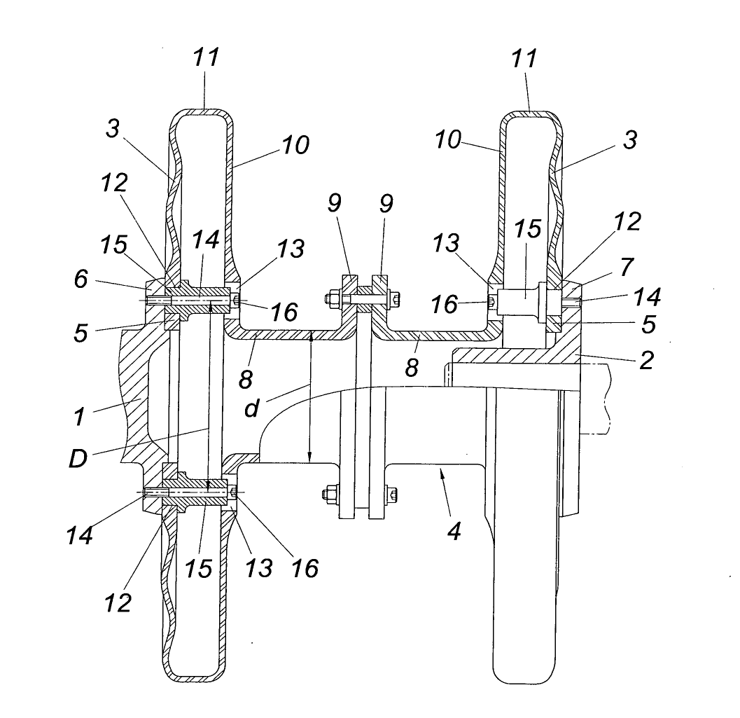

### FIELD OF THE INVENTION

The invention relates to a compensating coupling for a drive connection of two shafts with a coupling sleeve which is made of fiber-reinforced plastic and connects two face-side membranes and consists of two sleeve sections which are screwed together with each other via radially outwardly projecting connecting flanges, with the ring-disk-like membranes forming in the region of their inner circumference a connecting flange with pass-through holes for fastening screws, which holes are arranged along a graduated circle, and with the membranes being integrally joined to the coupling sleeve at their outside circumference.

### DESCRIPTION OF THE PRIOR ART

Compensating couplings with face-side membranes and a coupling sleeve connecting said membranes allow a simple compensation of shaft misalignment in the case of sufficient stiffness against torsion. In order to reduce the required space for installation and removing such compensating couplings, it is known (AT 403 837 B) to divide the coupling sleeve which is attached to the outside circumference of the membranes and to screw the two sleeve sections together via radially outwardly projecting connecting flanges. This measure ensures that it is possible to flange-mount the shaft on the motor side via the connecting flange provided in the region of the inner circumference of the membrane to the shaft on the motor side from the inside of the sleeve section before the other sleeve part with the associated membrane is inserted and the two sleeve sections are screwed together via their connecting flanges. The screwed connection between the gear-side shaft and the associated membrane must be made from the outside however, leading to an axial need for space corresponding to the length of the fastening screws on the side of the shaft flange of the gear-side shaft averted from the compensating coupling, which leads to an increase in the overall length and reduces the bending length of the compensating coupling. Apart from that, the flanging of the compensating coupling to the motor-side shaft from the inside of the associated sleeve section is cumbersome.

Moreover, it is known in connection with using a compensating coupling and a torsionally elastic coupling (AT 406 183 B) to arrange the torsionally elastic coupling within a sleeve section of the divided coupling sleeve of the compensating coupling whose other sleeve section has a smaller diameter and is joined to inner circumference of the face-side membrane, so that this membrane forms the connecting flange in the region of its outside circumference. Although the connecting flange of the membrane which is provided in the region of the outside circumference allows flanging this coupling part to the shaft flange from the coupling side outside of the sleeve section, this measure demands a respectively large shaft flange without being able to reduce the overall length because the other coupling part needs to be screwed together from the shaft side with the torsionally elastic coupling.

### SUMMARY OF THE INVENTION

The invention is thus based on the object of providing a compensating coupling of the kind mentioned above in such a way that not only the installation and removal conditions are improved, but that also there are more favorable constructional conditions concerning the overall length and the bending length.

This object is achieved by the invention in such a way that the coupling sleeve has a smaller outside diameter than the graduated circle diameter reduced by the diameter of the pass-through holes of the connecting flange, that the sleeve sections comprise face-side wall disks which are adjacent to the associated membranes through a circumferential wall, and that coaxial engagement openings for fastening screws are provided in the wall disks for the pass-through openings of the connecting flanges.

Since the coupling sleeve has a smaller outside diameter than the graduated circle diameter which is reduced by the diameter of the pass-through holes of the connecting flange, the two coupling parts can each be flanged on the adjacent shafts from the coupling side. For this purpose, the wall disks which are adjacent to the outside circumference of the membranes through a circumferential wall merely need to comprise engagement openings for fastening screws at the face sides of the sleeve sections, which pass-through openings can be inserted from the intermediate space between the wall disks on the one hand and the connecting flanges of the sleeve sections on the other hand, and can be tightened. The fastening of the two coupling parts from the coupling side does not require the need for any space axially outside of the compensating coupling, thus not only improving the installation and removing conditions but also achieving a reduction in the overall length and an increase in the bending length.

If the fastening screws rest on the head side on sleeves which are supported on the side of the connecting flanges of the membranes which is averted from the wall disk, then it is possible that comparatively large expansion lengths are achieved for the fastening screws due to the sleeve configuration, leading to a favorable dynamic securing of the screws. The torque to be transmitted is thus transmitted itself in a non-positive manner via the intrados of the hole and not via the fastening screws per se. The fastening screws can therefore form a predetermined breaking point for the connecting flange of at least one membrane, which point delimits the transmittable torque, when the frictional forces are exceeded in the region of the intrados of the hole and the fastening screws are loaded to shearing.

Since the sleeve sections are not directly adjacent to the outside circumference of the membranes due to their reduced outside diameter but are adjacent via wall disks, the possibility arises as a result of the wall disks which are arranged substantially parallel to the membranes to use these wall disks as membranes too, which are configured in a respectively stiffer way than the membranes on the face side which increases the displacement capabilities of the compensating coupling without having to make do with a sufficient safety against buckling which is otherwise more likely by a membrane with softer bending.

### BRIEF DESCRIPTION OF THE DRAWING

The object of the invention is shown in the drawing by way of example. A compensating coupling in accordance with the invention is shown in a simplified side view with a partly vertical sectional view.

### DESCRIPTION OF THE PREFERRED EMBODIMENT

The compensating coupling provided between a driven shaft 1 and a shaft 2 to be driven comprises membranes 3 on the face side which are connected with each other in a torsionally rigid fashion by a coupling sleeve 4 and form in the region of their inside circumference a connecting flange 5 for connecting the compensating coupling with the flanges 6, 7 of the driven shaft 1 and the shaft 2 to be driven. The coupling sleeve 4 made of fiber-reinforced plastic material is composed of two sleeve sections 8 which are screwed together with each other via radially outwardly projecting connecting flanges 9. On the face side opposite of the connecting flanges 9, the sleeve sections 8 carry wall disks 10 which are joined integrally via a circumferential wall 11 with the membranes 3.

For flanging the compensating coupling to the shaft flanges 6, 7, the connecting flanges 5 of the membranes 3 are provided with pass-through holes 12 whose graduated circle diameter is designated with D. Since the outside diameter d of the coupling sleeve 4 is smaller than the graduated circle diameter D which is reduced by the diameter of the pass-through holes 12 and the wall disks 10 with the pass-through holes 12 form aligned engagement openings 13 for fastening screws 14, the two coupling parts can be screwed together with the shaft flanges 6 from the coupling side. This screwed connection occurs via sleeves 15 which are supported on the same on the side of connecting flanges 5 facing the wall disks 10 and which themselves form an axial support for the screw head 16, so that a comparatively large expansion length can be ensured for the fastening screws 14 by the sleeves 15, which expansion length ensures a favorable dynamic securing of the screws. The transmission of torque occurs via the frictional forces in the region of the intrados of the hole. The fastening screws 14 can thus be used as a predetermined breaking point which delimits the maximum transmissible torque and which will be effective when after exceeding the frictional forces in the region of the intrados of the hole the fastening screws are loaded to shearing.

The wall disks 10 can be configured as membranes for enlarging the displacement capabilities of the compensating coupling, which membranes must be provided with a stiffer configuration than the membranes 3 on the face side in order to achieve the required safety against buckling. This ensures, in combination with a sufficient safety from buckling, that an offset of the two shafts 1, 2 arising from alignment and angle errors can be compensated which could not be compensated with the use of membranes of softer bending configuration due to the thus lacking safety from buckling.

1. A compensating coupling for a drive connection of two shafts with a coupling sleeve which is made of fiber-reinforced plastic and connects two face-side membranes and consists of two sleeve sections which are screwed together with each other via radially outwardly projecting connecting flanges, with the ring-disk-like membranes forming in the region of their inner circumference a connecting flange with pass-through holes for fastening screws, which holes are arranged along a graduated circle, and with the membranes being integrally joined to the coupling sleeve at their outside circumference, characterized in that the coupling sleeve (8) has a smaller outside diameter (d) than the graduated circle diameter (D) reduced by the diameter of the pass-through holes (12) of the connecting flange (5), that the sleeve sections (8) comprise face-side wall disks (10) which are adjacent to the associated membranes (3) through a circumferential wall (11), and that coaxial engagement openings (13) for fastening screws (14) are provided in the wall disks (10) for the pass-through openings (12) of the connecting flanges (5).

2. A compensating coupling according to claim 1, wherein the fastening screws (14) rest on the head side on sleeves (15) which are supported on the side of the connecting flanges (5) facing the wall disks (10).

3. A compensating coupling according to claim 2, wherein the fastening screws (14) form a predetermined breaking point for the connecting flange (5) of at least one membrane (3) which delimits the transmissible torque.

4. A compensating coupling according to claim 1, wherein the face-side wall disks (10) of the sleeve sections (8) form a stiffer membrane relative to the membranes to be connected.
